(19) United States
(12) Patent Application Publication
(10) Pub. No.: US 2009/0144167 A1
(43) Pub. Date: Jun. 4, 2009

(54) System and method for managing data and voice connectivity for wireless devices

(76) Inventor: Pablo Calamera, San Jose, CA (US)

Correspondence Address: MICROSOFT CORPORATION, ONE MICROSOFT WAY, REDMOND, WA, 98052, US

(21) Appl. No.: 11/058,785

(22) Filed: Feb. 15, 2005

Related U.S. Application Data
(60) Provisional application No. 60/652,109, filed on Feb. 10, 2005.

(51) Int. Cl. G06Q 30/00; H04W 72/00; G06F 17/30

(52) U.S. Cl. 705/26; 370/329; 707/3; 707/E17.108

(57) ABSTRACT

A system is described for managing wireless data access comprising. In one embodiment, the system includes a database to store user data for prepaid users and user data for postpaid users, the data for prepaid users including lease status data; a dispatcher to receive a request for data services from a wireless device, the dispatcher to query the database to determine whether the wireless device is associated with a prepaid account or a postpaid account on the wireless service provider, wherein if the wireless device is associated with a prepaid account, the dispatcher reads the lease status data to determine whether the account has a lease expiration indication and, if so, formats a lease renewal request according to a first data format over a local data network; a billing server to receive the lease renewal request from the dispatcher in the first data format and to reformat the request to a second data format, the second data format compatible with a charge control node (“CCN”) employed on the wireless service provider, the billing server to receive a response from the CCN indicating whether a lease associated with the wireless device is to be renewed and to reformat the response from the second data format to the first data format and to send the reformatted response to the dispatcher; and policy management logic executed on the dispatcher to block access to data services for the wireless device if the response indicates insufficient funds associated with the wireless device account or to allow access to data services if the response indicates a successful lease renewal.

### RELATED APPLICATIONS

The present invention is related to, and claims the benefit of U.S. Provisional Application No. ______, filed on Feb. 11, 2005. That application is incorporated by reference in its entirety.

### BACKGROUND OF THE INVENTION

1. Field of the Invention

This invention relates generally to the field of wireless data processing systems. More particularly, the invention relates to an improved architecture for managing data and voice connectivity for wireless networks.

2. Description of the Related Art

Virtually all wireless service providers today support both voice and data communication. By way of example, as indicated in FIG. 1, many wireless service providers that implement the Global System for Mobile Communications (“GSM”) standard 210 to support voice traffic, also implement the General Packet Radio Service (“GPRS”) standard 102 to support data traffic over the same wireless network. Wireless devices 110 coupled to the wireless network through GPRS 102 may communicate with external servers 125 such as Web servers, instant messaging servers and email servers via the Internet 120 (or other data network).

Service providers use various techniques to meter voice and data usage. For example, many service providers meter voice traffic on a per-minute basis and meter data traffic on a per-megabyte basis. Under this scenario, each minute of voice usage or each MByte of data usage over a specified limit is charged against the user's account 105. If the user's account is a “post-paid” account, then the charges are included in a bill which is sent to the user at the end of the billing cycle. By contrast, if the user's account is a “prepaid” account, then the charges are deducted directly from the current prepaid balance in the user's account. As indicated in FIG. 1, user's with prepaid accounts may replenish their accounts by purchasing prepaid service cards 115 from the service provider (i.e., and entering the prepaid service card information via the telephone or the Internet).

If the balance in a user's prepaid account reaches zero, the wireless service provider may disable both voice and data services. Typically, this is accomplished by completely de-provisioning and later re-provisioning the wireless device from the system which involves a significant amount of processing overhead (e.g., setting up data access paths, usage tracking, billing integration, etc). Accordingly, a more efficient mechanism for managing data services for prepaid accounts would be desirable.

### SUMMARY

A system is described for managing wireless data access comprising. In one embodiment, the system includes a database to store user data for prepaid users and user data for postpaid users, the data for prepaid users including lease status data; a dispatcher to receive a request for data services from a wireless device, the dispatcher to query the database to determine whether the wireless device is associated with a prepaid account or a postpaid account on the wireless service provider, wherein if the wireless device is associated with a prepaid account, the dispatcher reads the lease status data to determine whether the account has a lease expiration indication and, if so, formats a lease renewal request according to a first data format over a local data network; a billing server to receive the lease renewal request from the dispatcher in the first data format and to reformat the request to a second data format, the second data format compatible with a charge control node (“CCN”) employed on the wireless service provider, the billing server to receive a response from the CCN indicating whether a lease associated with the wireless device is to be renewed and to reformat the response from the second data format to the first data format and to send the reformatted response to the dispatcher; and policy management logic executed on the dispatcher to block access to data services for the wireless device if the response indicates insufficient funds associated with the wireless device account or to allow access to data services if the response indicates a successful lease renewal.

### BRIEF DESCRIPTION OF THE DRAWINGS

A better understanding of the present invention can be obtained from the following detailed description in conjunction with the following drawings, in which:

FIG. 1 illustrates a prior art system in which a wireless service provider manages both data and voice transactions.

FIG. 2 illustrates one embodiment of the invention which includes an external data management service.

FIG. 3 illustrates one particular embodiment of the external data management service.

FIG. 4a-b illustrate embodiments of processes implemented by the external data management service.

FIG. 5 illustrates a portion of a user database employed in one embodiment of the invention.

FIG. 6 illustrates an XML data format employed in one embodiment of the invention.

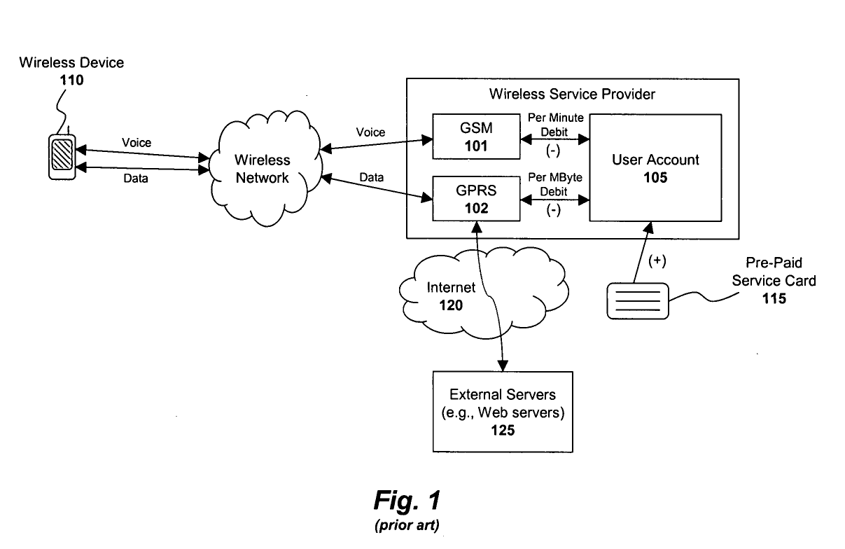

### DETAILED DESCRIPTION OF PREFERRED EMBODIMENTS

Described below is a system and method for managing data and voice connectivity for wireless devices. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

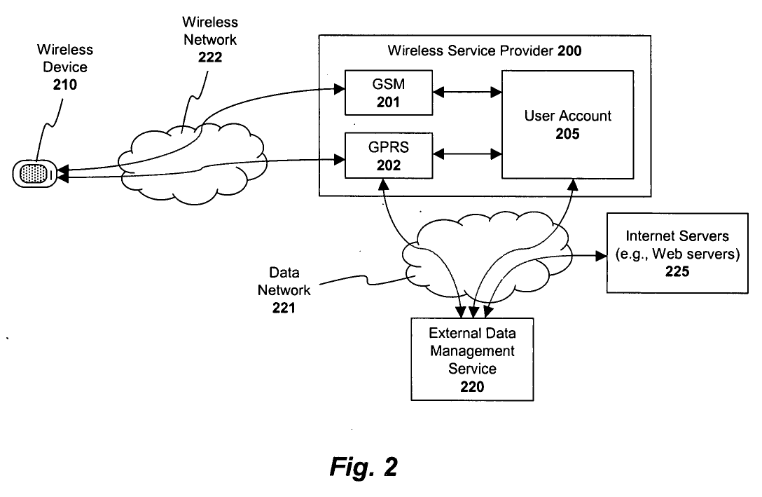

Embodiments of the invention may be implemented on an external data management service 220 such as that illustrated generally in FIG. 2. In one embodiment, the data management service 220 acts as a proxy between a wireless data processing device 210 and any external servers 225 with which the wireless device 210 communicates (e.g., e-mail servers and Web servers). For example, the data management service 220 may convert standard applications, multimedia content and data into a format which the wireless device 210 can properly interpret. One particular embodiment of the data management service is described in detail co-pending application entitled NETWORK PORTAL SYSTEM, APPARATUS AND METHOD, Ser. No. 09/714,897, Filed Nov. 15, 2000, which is assigned to the assignee of the present application and which is incorporated herein by reference. Additional embodiments of the data management service 220 geared specifically towards managing prepaid user accounts are described below.

In FIG. 2, the wireless network 222 is maintained by the service provider 200 at the physical/data link level of the OSI protocol stack. However, in one embodiment of the invention, policy management for access to data services is managed at the application level by the external data management service 220. Although the embodiment illustrated in FIG. 2 employs GSM 201 for voice traffic and GPRS 202 for data traffic, it should be noted that the underlying principles of the invention are not limited to any particular voice or data communication standard.

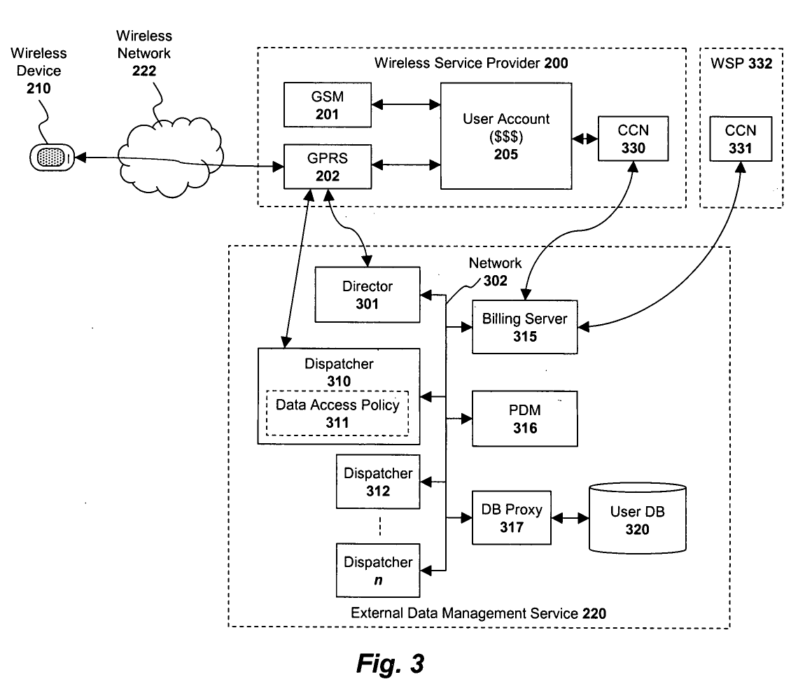

FIG. 3 illustrates additional details associated with one embodiment of the external data management service 220. This embodiment includes a director server 301, a plurality of dispatcher servers 310, 312, . . . n, a billing server 315, a premium download manager (“PDM”) server 316 and a database proxy server 317, all communicatively coupled to a network 302 (e.g., an Ethernet network). In one embodiment, each of the “servers” is implemented as a separate physical machine. Alternatively, each of the servers may be implemented as server processes within the same physical machine. The underlying principles of the invention remain the same regardless of the specific server implementation used.

In one embodiment, when a wireless device 210 initially attempts to access data services via GPRS 202, the director 301 assigns the wireless device to a particular dispatcher 310. The dispatcher 310 forms the central point of communications and policy management for data transmitted between the wireless device 210 and the service 220. In one embodiment, the dispatcher 310 maintains socket connections (e.g., TCP sockets) between the wireless device 210 and the various proxy servers maintained on the service 220. For example, for an e-mail session, the dispatcher 310 opens and maintains a socket connection between the wireless device 210 and an e-mail proxy server (not shown). Similarly, for other wireless applications (e.g., instant messaging, Web browsing, . . . etc) the dispatcher 310 establishes and maintains socket connections between the wireless device 210 the appropriate proxy server (e.g., an instant messaging proxy server, a Web proxy server, . . . etc). Additional details associated with this architecture are described in co-pending application entitled APPARATUS AND METHOD FOR DISTRIBUTING ELECTRONIC MESSAGES TO A WIRELESS DATA PROCESSING DEVICE, Ser. No. 10/236,255, Filed Sep. 5, 2002, which is assigned to the assignee of the present application and which is incorporated herein by reference.

In one embodiment, each time a user logs into or out of the service 220, the dispatcher 310 notifies the DB proxy 317 to update the user's online status within the user database 320 accordingly. In addition, given the significant differences in bandwidth between the wireless network 120 and the local network 302 on which the service 220 operates, the dispatcher 310 may temporarily buffer data transmitted to and from the wireless device 210 over each individual socket connection.

If the physical/data link connection between the wireless device 210 and service provider 200 is temporarily lost (e.g., because the user passes through a tunnel), the user will not immediately be disconnected from the dispatcher. Rather, the user's “online” status will be maintained within the user database 320 for a specified period of time (e.g., 10 minutes), along with an indication of the dispatcher 310 through which the wireless device is connected.

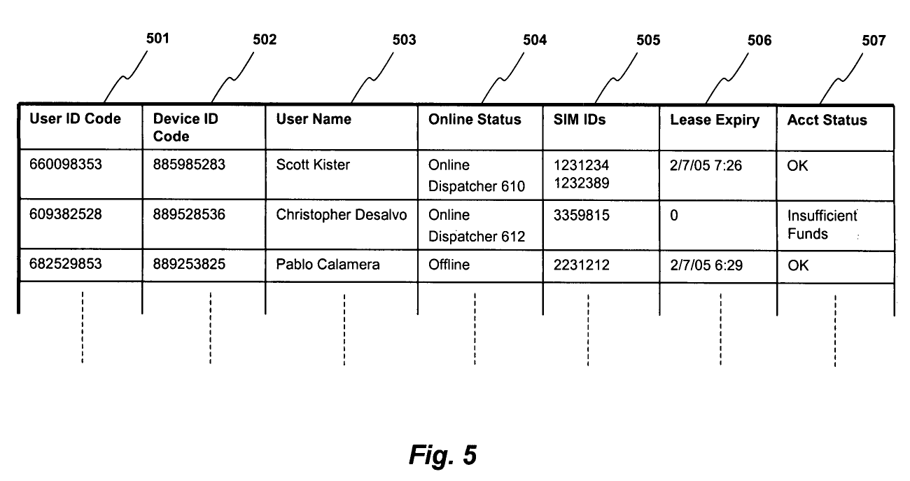

An exemplary portion of the user database 320 is illustrated in FIG. 5, which contains a mapping of user identification codes 501 to data processing device identification codes 502. The user ID/device ID mapping is used by the service 220 to identify the particular wireless device 210 to which data and account information should be transmitted for a given user. In addition, the user database 320 contains the user's account name 503, the user's online status 504, including the particular dispatcher 310 through which the wireless device 210 is communicating, and the Subscriber Identity Module (“SIM”) identification codes 505 associated with the user (the user may maintain more than one SIM).

For pre-paid users, a timestamp referred to herein as a “lease expiry” value 506 is stored in the database to indicate the time at which the user's current “lease period” expires. As described in greater detail below, when the lease expiry time is reached, the external data management service 220 will query the user's account 205 at the wireless service provider 200 in an attempt to renew the lease. If the renewal is successful, the lease expiry value 506 is reset within the database. If, however, the renewal is unsuccessful, then an insufficient funds indication 507 is stored within the database.

It should be noted that a single table is illustrated in FIG. 5 merely for the purpose of explanation. In operation, the database may be a relational database comprised of a plurality of interrelated tables containing the information shown in FIG. 5.

In one embodiment, the dispatcher 310 implements a data access policy 311 based on the lease expiry period 506 and/or the insufficient funds indication 507. For example, if the database indicates that the user's account has insufficient funds, then the dispatcher 310 may disable or limit the user's access to data services. Because policy management for data services is provided at the application layer by the external data management service 220 (rather than at the physical/data link layer as in prior systems), the wireless device does not need to be de-provisioned by the wireless service provider 200 and then later re-provisioned for data access, thereby saving the wireless service provider 200 a significant amount of processing overhead.

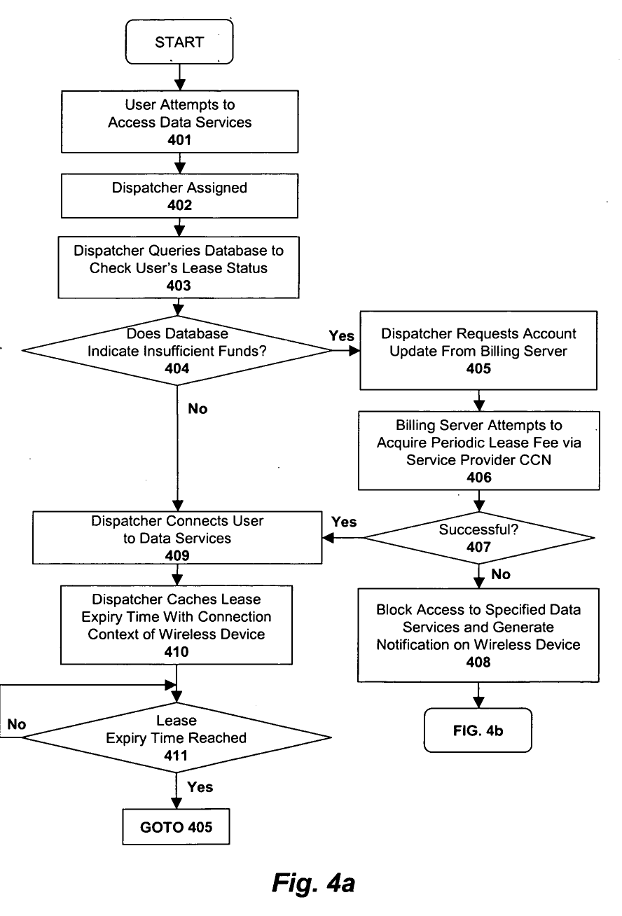

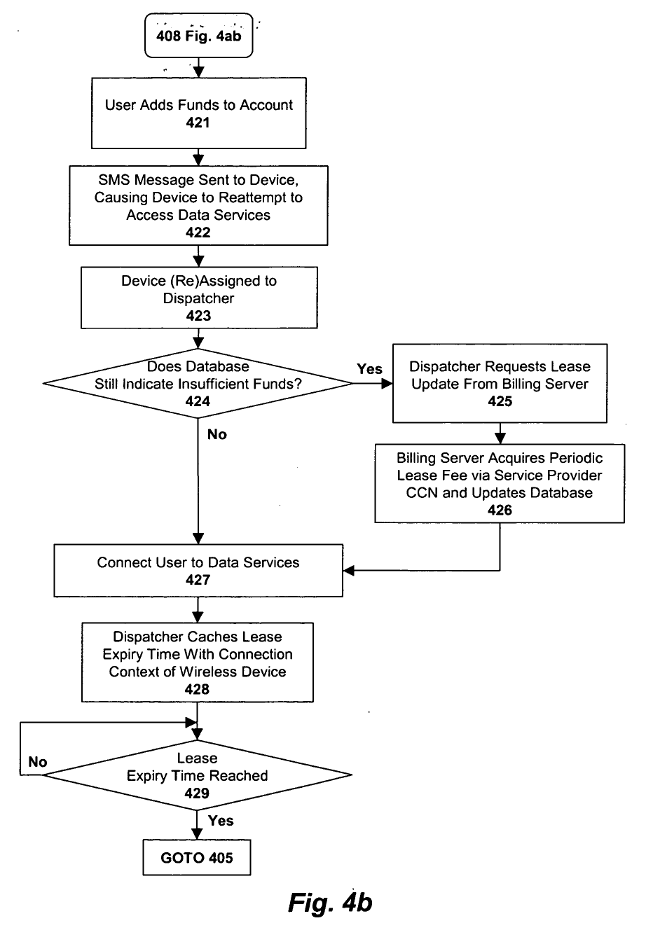

One particular embodiment of a process implemented by the external data management service 220 is illustrated in FIG. 4a. The process may be implemented as part of a pre-paid lease arrangement in which the end-user of the wireless data processing device 210 agrees to lease data services for a fixed rate over a fixed period of time (e.g., $1.00 per day).

Turning now to the process, at 401, a user attempts to access data services over the wireless network 222 (e.g., browse the Web, enter into an instant messaging session, etc). At 402, a dispatcher 310 is assigned to process the user's request and implement the data access policy described herein. As mentioned above, if the user has previously accessed data services within a predetermined period of time (e.g., 10 minutes), then the user is still considered “online” and is re-connected with the same dispatcher to which the user was previously assigned.

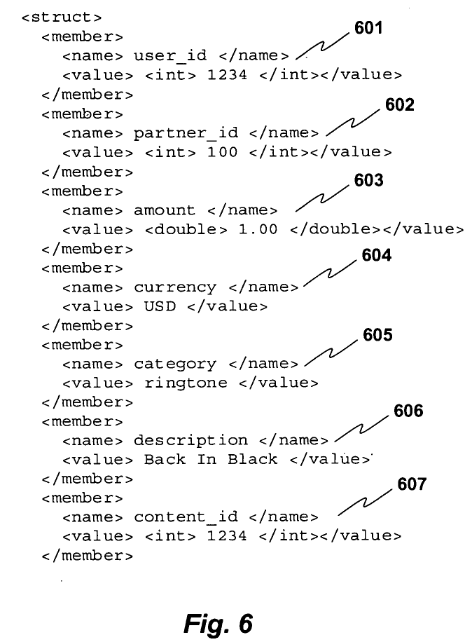

At 403, the dispatcher 310 queries the user database 320 via the database proxy server 317 to determine the user's account status. If the database indicates that the user is a “prepaid” user and that user's account has “insufficient funds” then, at 405, the dispatcher transmits a request to the billing server 315 to retrieve an account update from the wireless service provider 200. As described below with respect to FIG. 6, in one embodiment, the request is formatted in an Extensible Markup Language/Remote Procedure Call (“XML-RPC”) format.

At 406, the billing server 315 attempts to renew the lease by debiting the previously-agreed upon periodic lease fee from the service provider (e.g., $1.00/day). In one embodiment, the billing server 315 communicates with a charge control node (“CCN”) 330 at the service provider to perform the debit operation. More specifically, in one embodiment, the CCN is an Ericsson CCN which communicates with the billing server using the Diameter interface specifications over a TCP/IP communication channel. If an XML-RPC format is used for the request between the dispatcher and the billing server, then the billing server reformats the data from the request into a format compatible with the Diameter interface specifications (and vice versa upon receiving the CCN's response). It should be noted, however, that the underlying principles of the invention are not limited to any particular CCN communication protocol or internal data communication format. As illustrated in FIG. 3, the same billing server 315 may be configured to communicate with other CCNs (e.g., CCN 331) at other wireless service providers (e.g., WSP 332).

If the CCN is unable to acquire the periodic lease amount from the user's account 205, determined at 407, then the CCN returns a “renew lease failure” indication to the billing server 315. The billing server 315 communicates the failure to the dispatcher 310 and, at 408, the dispatcher blocks and/or limits data services to the wireless device 210. In addition, at 408, a message is sent to the wireless device 210 indicating a failed login due to insufficient funds.

At either 404 or 407, if it is determined that sufficient funds exist to renew the user's lease agreement, then at 410 the dispatcher 310 couples the wireless device to data services and caches the lease expiry time with the connection context of the wireless device. When the lease expiry time is reached, determined at 411, the dispatcher 310 again requests a lease renewal from the billing server and the process returns to 405.

FIG. 4b illustrates one embodiment of a process by which external data management service 220 reactivates data services for a deactivated data processing device 210. At 421, the user adds funds to his or her account on the wireless service provider 200 (e.g., by purchasing a prepaid-data services card from a service provider location as descried above). At 422, in response to the addition of funds, the service provider 200 transmits a short message service (“SMS”) message to the wireless device 210 via GSM 201 (or other voice or data channel which supports SMS). In one embodiment, the SMS message contains a remote method invocation (“RMI”) causing the data processing device to automatically attempt to reconnect to data services controlled by the data management service 220. Alternatively, or in addition, at 422 the user may choose to sign in to the data management service 220 manually (e.g., via a standard login procedure).

In response, at 423, the director 301 assigns the wireless device 210 to a particular dispatcher 310. The dispatcher may again query the database to determine whether the insufficient funds indication still exists at 424. If so, then at 425, the dispatcher transmits a request to the billing server 315 to retrieve an account update from the wireless service provider 200. At 426, the billing server renews the lease by communicating with the CCN, causing the CNN to debit the periodic lease fee from the service provider, and updating the database.

At 427, the user's account has been updated and the dispatcher once again provides the wireless device with access to data services. At 428, the dispatcher 310 couples the wireless device 210 to data services and caches the lease expiry time with the connection context of the wireless device. When the lease expiry time is reached, determined at 429, the dispatcher 310 again requests a lease renewal from the billing server 315 and the process returns to 405 in FIG. 4a.

Performing data access policy management at the dispatcher rather than at the wireless service provider provides various benefits over prior systems. For example, as mentioned above, if a prepaid user has insufficient funds, the wireless device does not need to be de-provisioned and then later re-provisioned by the wireless service provider 200, thereby saving the wireless service provider significant processing overhead. In addition, a finer granularity of management and control may be implemented over data access. For example, in one embodiment, the dispatcher may provide access to certain types of information even though the user's prepaid account has insufficient funds. The information may include, but is not limited to, a catalog of content available via the PDM (described below), clock synchronization data (to keep the wireless device's clock synchronized with the service 220), and basic types of notifications such as the existence of pending email or instant messages.

The premium download manager (“PDM”) 316 employed in one embodiment of the invention allows both prepaid users and postpaid users to purchase various types of content directly from the wireless device 210. The content may include, by way of example and not limitation, new ring tones for the wireless device, graphical images, video, encoded audio (e.g., MP3 or AAC files), games and/or applications.

In one embodiment, when a user attempts to purchase content from the data management service 220, the PDM 316 initially queries the database 320 (via the DB proxy 317) to determine whether the user is a “prepaid” user. If so, then the PDM transmits a charge request to the billing server 315. In one embodiment, the charge information is encapsulated in an XML-RPC format, one example of which is illustrated in FIG. 6. The exemplary charge request shown in FIG. 6 includes an indication of who the user is 601, an indication of the service provider 602 (i.e., so that the billing server communicates with the appropriate CCN), an indication of the price of the requested content 603, an indication of the currency used for the charge 604, an indication of the product category 605 (e.g., “Ring Tone”), a short product description 606 (e.g., “Back in Black”), and/or a content ID 607 (e.g., an integer identifying the specific requested content). In one embodiment, the same XML-RPC format as that used for the PDM charge information is also used for the lease renewal request (e.g., with the charge amount set equal to the lease amount and the category set to “lease renewal”). Of course, various other/additional information may be included within the charge request while still complying with the underlying principles of the invention.

In response to the charge request, the billing server 315 extracts the user ID, price and/or other information from the XML structure and reformats the data for transmission to the CCN 330. As mentioned above, in one embodiment, the billing server 315 formats the data according to the Diameter interface specifications and transmits the formatted data over a TCP/IP communication channel.

Upon receiving the charge request from the billing server 315, the CCN 330 attempts to debit the user's account 205 by the charge amount. As in the case of the prepaid lease arrangement described above, if the user has sufficient funds then the account will be debited by the charge amount. The CCN will communicate the successful charge to the billing server 316 which will reformat the successful charge (e.g., to an XML-RPC format) and notify the PDM. In response, the PDM will permit the user to download the requested content (e.g., from a content database (not shown)).

However, if the user has insufficient funds to cover the price of the charge, then the CCN communicates an “insufficient funds” message to the billing server 315. The billing server 315 reformats the data (e.g., to an XML-RPC format) and transmits the reformatted response to the PDM 316, which disallows the requested download.

In addition, in one embodiment, the billing server 315 caches an indication of the disallowed request and the amount of the request for a specified period of time. During this specified period of time, if the user attempts to request additional content or to renew a lease period at a price equal to or less than that of the first request, then the billing server will respond with a lease/request failure without transmitting the request to the billing server CCN 330. If, however, the request is less than the initial request, then the billing server 315 may transmit an additional request to the CCN 330.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, although each of the functional modules illustrated in FIG. 3 is described herein as a separate “server,” it will be readily apparent to those of skill in the art that the functional modules may be grouped within a single server or spread across multiple servers while still complying with the underlying principles of the invention. Accordingly, the scope and spirit of the invention should be judged in terms of the claims which follow.

1. A system for managing wireless data access comprising:
a database to store user data associated with wireless service provider user accounts, the database including user data for prepaid users and user data for postpaid users, the data for prepaid users including lease status data;
a database proxy server to provide
a dispatcher to receive a request for data services from a wireless device, the dispatcher to query the database to determine whether the wireless device is associated with a prepaid account or a postpaid account on the wireless service provider, wherein if the wireless device is associated with a prepaid account, the dispatcher reads the lease status data to determine whether the account has a lease expiration indication and, if so, formats a lease renewal request according to a first data format over a local data network, to establish and maintain socket connections on behalf of the wireless device with one or more proxy servers and to temporarily buffer data transmitted to and from the wireless device over each individual socket connection;
a billing server to receive the lease renewal request from the dispatcher in the first data format and to reformat the request to a second data format, the second data format compatible with a charge control node (“CCN”) employed on the wireless service provider, the billing server to receive a response from the CCN indicating whether a lease associated with the wireless device is to be renewed and to reformat the response from the second data format to the first data format and to send the reformatted response to the dispatcher; and
policy management logic to limit access to data services for the wireless device if the response indicates insufficient funds associated with the wireless device account or to allow access to data services if the response indicates a successful lease renewal, wherein the policy management logic allows access to certain specified information for the wireless device even if the response indicates insufficient funds associated with the wireless device.

2. The system as in claim 1 wherein the first data format is an extensible markup language/remote procedure call (“XML-RPC”) format.

3. The system as in claim 1 wherein limiting access to data services comprises blocking access to data services.

4. The system as in claim 1 wherein the second data format comprises Diameter interface specifications over a TCP/IP communication channel.

5. The system as in claim 1 wherein if the wireless device is initially blocked by the policy management logic due to insufficient funds, and a user reattempts to access data services after a specified period of time, the dispatcher again reads the lease status data from the database to determine whether the account still has a lease expiration indication and, if so, formats another lease renewal request according to the first data format over the local data network; and wherein the billing server determines via the CNN whether the wireless device account still has insufficient funds and to communicate back to the dispatcher; and wherein the policy management logic executed on the dispatcher again limits access to data services for the wireless device if the response indicates insufficient funds or allows access to data services if the response indicates a successful lease renewal.

6. The system as in claim 1 further comprising:
a premium download manager to manage content requested and/or downloaded by the wireless device, wherein when a wireless device is associated with a prepaid account, the premium download manager transmits a charge request to the billing server in the first data format in response to a request to purchase content sent from the wireless device, the billing server converting the request to the second format and transmitting the request to the CCN,
wherein if the CCN indicates that the user has sufficient funds to make the content purchase, the premium download manager allows the content to be transmitted to the wireless device; and
wherein if the CCN indicates that the user has insufficient funds to make the content purchase, the premium download manager prohibits the content from being downloaded to the wireless device.

7. The system as in claim 1 further comprising:
a director server to initially receive the request for data services from the wireless device and to forward the request to a particular dispatcher.

8. The system as in claim 7 wherein the director selects the particular dispatcher by querying the database to determine whether the wireless device is registered as “online” within the database and, if so, identifying the particular dispatcher from the database.

9. The system as in claim 1 further comprising:
a database proxy server to receive database queries formatted according to the first data format and to convert the database queries into a third format compatible with the database.

10. The system as in claim 1 further comprising:
a proxy to retrieve content from the Internet in response to requests from the wireless device, convert the content into a format which the wireless device can interpret, and forward the converted content to the wireless device via the wireless service provider.

11. The system as in claim 1 wherein limiting access by the policy management logic comprises allowing only certain specified types of notifications to be sent to the wireless device.

12. The system as in claim 1 wherein if the policy management logic allows access to data services, the dispatcher couples the wireless device to data services and caches the lease expiration indication with a connection context of the wireless device.

13. The system as in claim 12 wherein, when the lease expiration indication comprises a lease expiry time, wherein when the lease expiry time is reached, the dispatcher again formats a lease renewal request according to a first data format over a local data network to the billing server.

14. The system as in claim 1 wherein each of the servers comprise individual processes within a single physical machine.

15. The system as in claim 1 wherein the policy management logic is executed on the dispatcher.

16. A system comprising:
database means to store user data associated with wireless service provider user accounts, the database means including user data for prepaid users and user data for postpaid users, the data for prepaid users including lease status data;
dispatcher means to receive a request for data services from a wireless device, the dispatcher means to query the database means to determine whether the wireless device is associated with a prepaid account or a postpaid account on the wireless service provider, wherein if the wireless device is associated with a prepaid account, the dispatcher means reads the lease status data to determine whether the account has a lease expiration indication and, if so, formats a lease renewal request according to a first data format over a local data network, the dispatcher means further to establish and maintain socket connections on behalf of the wireless device with one or more proxy servers and to temporarily buffer data transmitted to and from the wireless device over each individual socket connection;
billing means to receive the lease renewal request from the dispatcher means in the first data format and to reformat the request to a second data format, the second data format compatible with a charge control node (“CCN”) employed on the wireless service provider, the billing means to receive a response from the CCN indicating whether a lease associated with the wireless device is to be renewed and to reformat the response from the second data format to the first data format and to send the reformatted response to the dispatcher means; and
policy management means to limit access to data services for the wireless device if the response indicates insufficient funds associated with the wireless device account or to allow access to data services if the response indicates a successful lease renewal, wherein the policy management logic allows access to certain specified information for the wireless device even if the response indicates insufficient funds associated with the wireless device.

17. The system as in claim 16 further comprising:
premium download means to manage content requested and/or downloaded by the wireless device, wherein when a wireless device is associated with a prepaid account, the premium download means transmits a charge request to the billing means in the first data format in response to a request to purchase content sent from the wireless device, the billing means converting the request to the second format and transmitting the request to the CCN,
wherein if the CCN indicates that the user has sufficient funds to make the content purchase, the premium download means allows the content to be transmitted to the wireless device; and
wherein if the CCN indicates that the user has insufficient funds to make the content purchase, the premium download means prohibits the content from being downloaded to the wireless device.

18. The system as in claim 16 further comprising:
director means to initially receive the request for data services from the wireless device and to forward the request to a particular dispatcher means.

19. The system as in claim 18 wherein the director means selects the particular dispatcher means by querying the database means to determine whether the wireless device is registered as “online” within the database means and, if so, identifying the particular dispatcher means from the database means.

20. The system as in claim 16 further comprising:
proxy means to receive database queries formatted according to the first data format and to convert the database queries into a third format compatible with the database means.

21. The system of claim 1, wherein the information comprises a catalog of content available via a premium download manager.

22. The system of claim 1, wherein the information comprises clock synchronization data.

23. The system of claim 1, wherein the information comprises notifications of the existence of pending messages.

24. The system of claim 1, wherein the policy management logic is to reactivate data services for the wireless device if the response indicates a successful release renewal.

25. The system of claim 24, wherein the wireless service provider transmits a short message service message to the wireless device to reactivate data services.

26. The system of claim 25, wherein the short message service message comprises a remote method invocation, the remote method invocation causing the wireless device to automatically attempt to reconnect to data services controlled by the dispatcher.
